(19) United States
(12) Patent Application Publication
(10) Pub. No.: US 2007/0287324 A1
(43) Pub. Date: Dec. 13, 2007

(54) Water block and method of manufacturing the same

(76) Inventors: Phon-Quan Lee, Chung-Ho City (TW); Chia-Chun Cheng, Chung-Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/806,859

(22) Filed: Jun. 5, 2007

(30) Foreign Application Priority Data
Jun. 13, 2006 (TW) 95121044

(51) Int. Cl. H01R 4/26

(52) U.S. Cl. 439/441

(57) ABSTRACT

A water block includes a first casing, a solder paste, and a second casing. The first casing has a solder reserve area formed on an outer edge thereof. The solder paste is coated on the solder reserve area. The second casing is jointed with the first casing via the solder past to form a channel space. The present invention uses tin solder as a soldering material, so that the soldering temperature is between 200° C. and 400° C. Hence, the present invention avoids oxygenation and weakened bond strength due to high temperatures. Therefore, when the solder paste melts, the flux separates from the tin solder and bubbles of the tin solder are removed from the solder reserve area at a soldering temperature of between 200˜400° C. Moreover, the bond strength of the joint surface between two casings is increased, so cooling liquids won't easily leak out from the strong joint surface.

### BACKGROUND OF THE INVENTION

1. Field of the Invention

The present invention relates to a water block and a method of manufacturing the same, and particularly relates to a solder reserve area being designed between two casings and a solder past filled in the solder reserve area for reducing the soldering temperature and increasing the bonding strength.

2. Description of the Related Art

Over the years, the processing speed and complexity of chips have become faster and higher, thus generating larger amounts of heat from the chips. In order to dissipate the heat from the heat source to the outside, a heat-dissipating device and a fan are usually used to help dissipate the heat. However, heat-dissipating devices are incapable of effectively dissipating large amounts of heat from chips. Hence, a water-cooling heat-dissipating device is commonly used to dissipate heat from the heat source. The water-cooling heat-dissipating device includes a water block, a heat sink, and a guiding tube between the water block and the heat sink. The working principle of the water-cooling heat-dissipating device is that the water block is arranged on a chip, and heat generated from the chip is guided to the water block, the heat of the water block is then guided quickly to the heat sink to be cooled by cooling liquids that circulate between the water block and the heat sink. Hence, the chip works normally at a low temperature.

Referring to FIG. 1, a known water block has a first casing 1a and a second casing 2a. The casings 1a, 2a are made of good heat-dissipating materials. The first casing 1a and the second casing 2a are jointed together to form a channel space 4a. A joint between the first casing 1a and the second casing 2a has a joint surface 3a. A solder paste is coated on the joint surface 3a in order to solder the first casing 1a and the second casing 2a together. The soldering method includes a soft soldering and a hard soldering. Regarding the soft soldering, the solder past is firstly coated on the joint surface 3a, and then the solder past is melted under 400° C. for soldering the first casing 1a and the second casing 2a. The advantages of the soft soldering are that temperature is low, the structure is not damaged, and cost is low. A defect of soft soldering is that bubbles are generated on the joint surface. Hence, the bond strength between the first casing 1a and the second casing 2a is decreased. Moreover, the water block has a strong internal pressure due the flow of the cooling liquids in the water block, so that the cooling liquids leak out from the weak joint surface 3a easily.

Regarding hard soldering, the material of the solder past is similar to pre-soldering matter. For example, a copper material is used as the solder paste and the copper is melted at between 600° C. and 700° C. in order to solder the first casing 1a and the second casing 2a together. The advantage of the hard soldering is that the bond strength between the first casing 1a and the second casing 2a is increased. The defects of the hard soldering are that the working temperature is very high, so that the structure can be easily damaged due to oxygenation, and that the cost is high.

In conclusion, the structure and soldering method of a known water block needs to be improved. Moreover, it is necessary to develop a new water block in order to meet the requirements of the market. The water block needs to have some advantages such as low cost, high bonding strength between the casings, and having highly air-tight properties.

### SUMMARY OF THE INVENTION

The present invention provides a water block and a method of manufacturing the same. The present invention uses tin solder as a soldering material, so that only a soldering temperature of between 200° C. and 400° C. is required. Hence, the present invention avoids oxygenation and weakened bond strength due to high temperatures. Because flux occupies about 5˜15% of the content of tin solder, the rate of bubbles is less than that of the prior art. Therefore, when solder paste is melted, the flux separates from the tin solder and bubbles of the tin solder are removed from the solder reserve area at a soldering temperature of between 200˜400° C. Moreover, the bond strength of the joint surface between the two casings is increased, so that cooling liquids will not easily leak out from the strong joint surface.

A first aspect of the present invention is a water block. The water block comprises: a first casing, a solder paste, and a second casing. The first casing has a solder reserve area formed on an outer edge thereof. The solder paste is coated on the solder reserve area. The second casing is jointed with the first casing via the solder past to form a channel space. Moreover, the solder reserve area is a gap formed at a joint between the first casing and the second casing.

A second aspect of the present invention is a water block. The water block comprises: a first casing, a third casing, a solder paste, and a second casing. The first casing has a solder reserve area formed on an outer edge thereof. The third casing has a solder reserve area formed on an outer edge thereof. The solder paste is coated on the two solder reserve areas. The second casing is jointed with the first casing and the third casing via the solder past to form a channel space. Moreover, the two solder reserve areas are two gaps respectively formed at two joints between the first casing and the second casing and between third casing and the second casing.

A third aspect of the present invention is a method of manufacturing a water block, comprising: providing a first casing that has a solder reserve area formed on an outer edge thereof; coating a solder paste on the solder reserve area, wherein the solder past is composed of tin solder and flux, and the flux occupies about 5˜15% of the content of the tin solder; jointing a second casing with the first casing via the solder past to form a channel space; and separating the flux from the tin solder and removing bubbles of the tin solder from the solder reserve area at a soldering temperature of between 200˜400° C.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a perspective view of a water block of the prior art;

FIG. 2 is a perspective view of a water block according to the first embodiment of the present invention;

FIG. 3 is a cross-sectional view along the line 3-3 of FIG. 2;

FIG. 4 is a perspective view of a water block according to the second embodiment of the present invention;

FIG. 5 is a cross-sectional view along the line 5-5 of FIG. 4;

FIG. 6 is a perspective view of a water block according to the third embodiment of the present invention;

FIG. 7 is a cross-sectional view of a first type of water block of FIG. 6;

FIG. 8 is a cross-sectional view of a second type of water block of FIG. 6;

FIG. 9 is a cross-sectional view of a third type of water block of FIG. 6; and

FIG. 10 is a flowchart of a method of manufacturing a water block of the present invention.

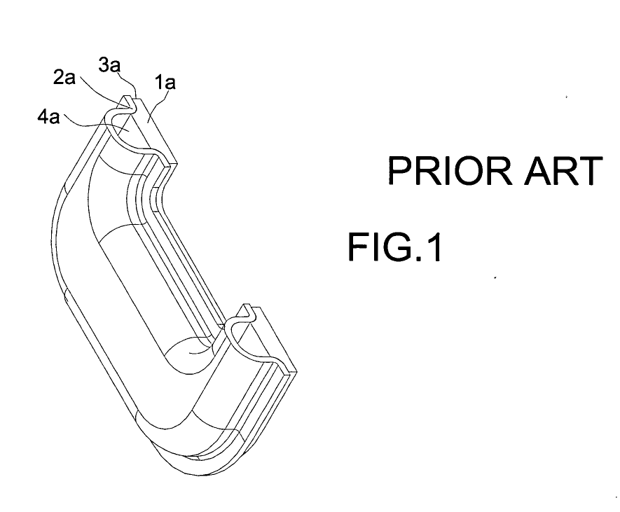

### DETAILED DESCRIPTION OF PREFERRED BEST MOLDS

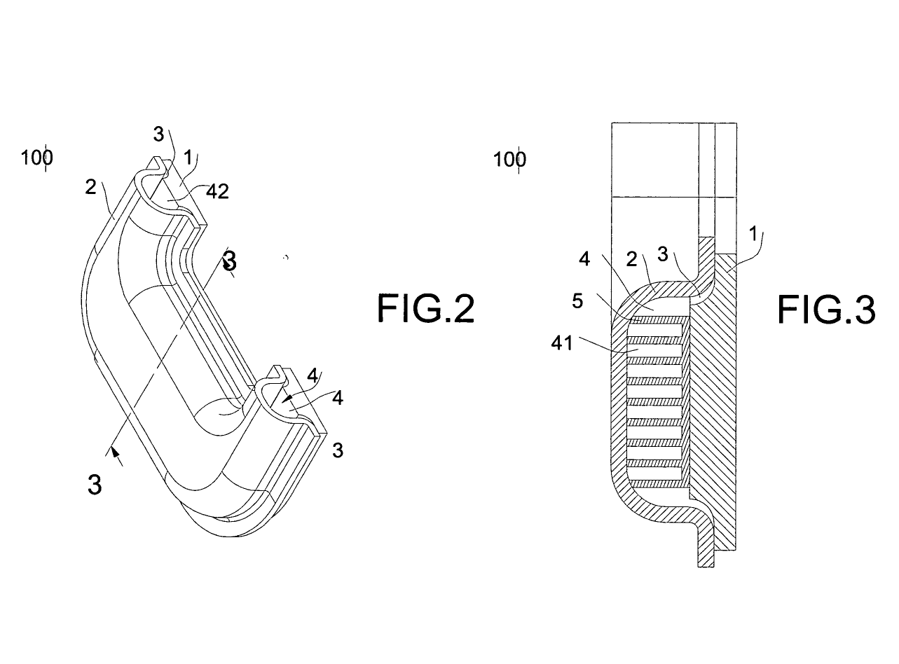

Referring to FIGS. 2 and 3, the first embodiment of the present invention provides a water block 100 that comprises a first casing 1, a second casing 2, and a plurality of fins 5.

The first casing 1 has a solder reserve area 3 formed on an outer edge thereof. When the first casing 1 joints with the second casing 2, the solder reserve area 3 becomes a gap formed at an inner side of a joint between the first casing 1 and the second casing 2. The first casing 1 joints with the second casing 2 to form a channel space 4, a passage hole 42, and a passage hole 43. The two passage holes 42, 43 respectively joint with two guiding tubes (not shown). The fins 5 are attached onto the first casing 1 so as to divide the channel space 4 into a plurality of flow channels 41. In other embodiment, the fins 5 are disposed on the second casing 2, or on the first casing 1 and the second casing 2. Hence, the fins can be integratedly formed on the first casing 1 and/or the second casing 2.

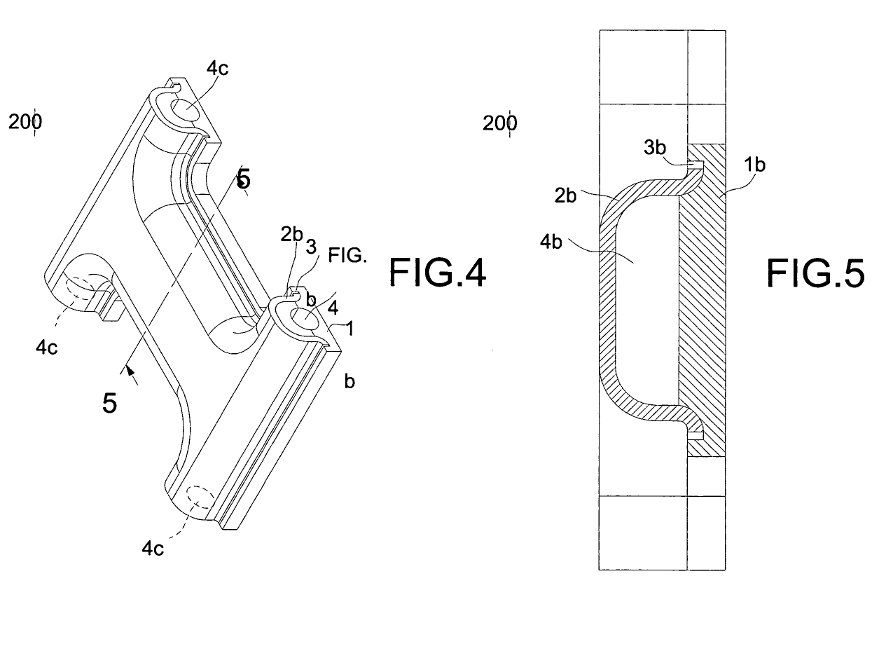

Referring to FIGS. 4 and 5, the second embodiment of the present invention provides a water block 200 that comprises a first casing 1b and a second casing 2b. The water block 200 is H-shaped, and the first casing 1b and the second casing 2b joint together to form a channel space 4b and four passage holes 4c. The first casing 1b has a U-shaped groove formed on an outside edge thereof. An outside edge of the second casing 2b is received in the U-shaped groove in order to joint the first casing 1b and the second casing 2b together. A solder reserve area 3b, which is also a gap, is formed at an outer side of a joint between the first casing 1b and the second casing 2b. Fins (not shown) can be disposed on the first casing 1b and/or the second casing 2b in order to divide the channel space 4b into a plurality of flow channels (not shown).

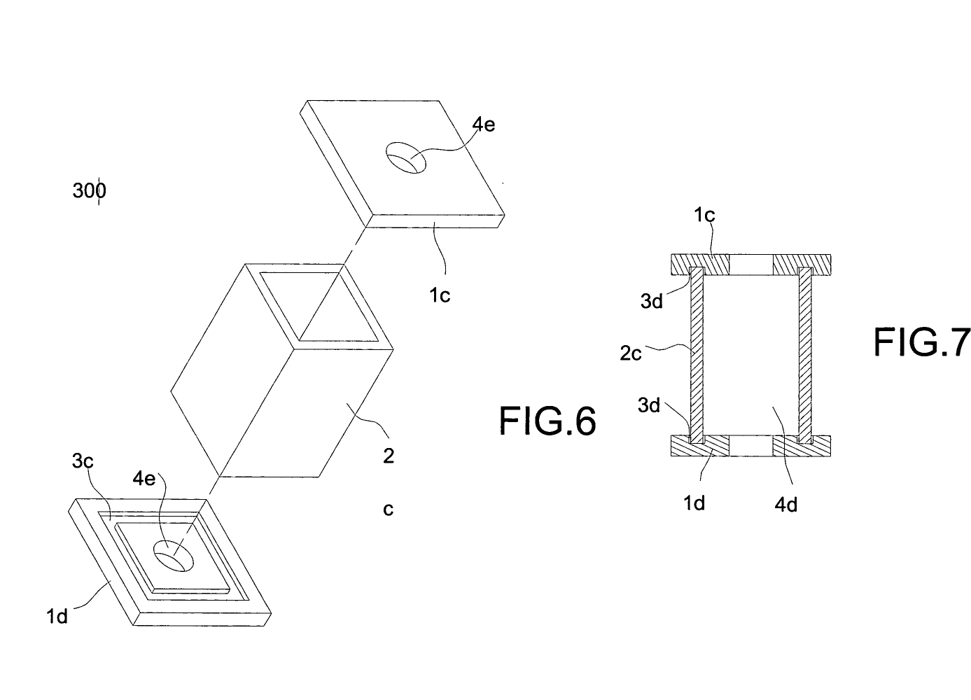

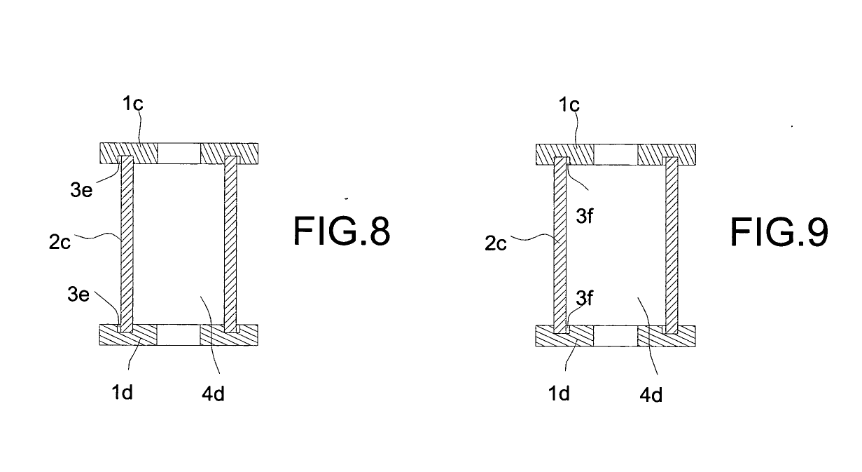

Referring to FIGS. 6 and 7, the third embodiment of the present invention provides a water block 300 that comprises a first casing 1c, a second casing 2c with a square post shape, and a third casing 1d. The first casing 1c, the second casing 2c, and the third casing 1d joint together to form a channel space 4d. The first casing 1c has a passage hole 4e formed thereon and an annular concave groove 3c formed on an inside thereof. The third casing 1d has a passage hole 4e formed thereon and an annular concave groove 3c formed on an inside thereof. The annular concave groove 3c has a width larger than that of a thickness of a sidewall of the second casing 2c. Two sides of the second casing 2c are received into the two annular concave grooves 3c of the first casing 1c and the third casing 1d in order to joint the first casing 1c and the third casing 1d on the two sides of the second casing 2c. Hence, solder reserve areas 3d can be formed at two outer sides and two inner sides of two joints between the first casing 1c and the second casing 2c and between the second casing 2c and the third casing 1d. In another embodiment, referring to FIG. 8, the thickness of the second casing 2c is smaller, so that the solder reserve areas 3e are formed at the two outer sides of two joints between the first casing 1c and the second casing 2c and between the second casing 2c and the third casing 1d. According to the same principle, referring to FIG. 9, the thickness of the second casing 2c is larger, so that the solder reserve areas 3f are formed at the two inner sides of two joints between the first casing 1c and the second casing 2c and between the second casing 2c and the third casing 1d. The second casing 2c further includes a plurality of fins (not shown) in order to divide the channel space 4d into a plurality of flow channels (not shown).

The above-mentioned passage holes can be design to fit guiding tubes with any shapes. Moreover, according to the above-mentioned disclosures, the solder reserve areas can be disposed between any two casings.

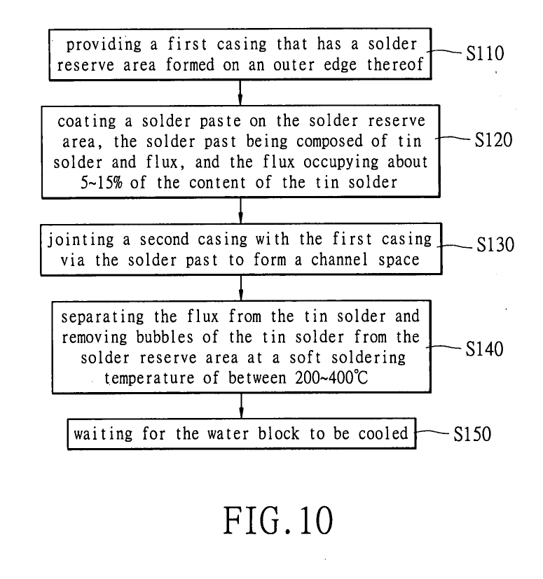

Referring to FIG. 10, the present invention provides a method of manufacturing a water block. The method of steps comprises: providing a first casing that has a solder reserve area formed on an outer edge thereof (S110); coating a solder paste on the solder reserve area, the solder past being composed of tin solder and flux, and the flux occupying about 5˜15% of the content of the tin solder (in the range of 5˜15%, the rate of bubbles is 10.5%) (S120); jointing a second casing with the first casing via the solder past to form a channel space (the solder past is filled into the solder reserve area that is a gap between the first casing and the second casing) (S130); separating the flux from the tin solder and removing bubbles of the tin solder from the solder reserve area at a soft soldering temperature of between 200˜400° C. (S140); and waiting for the water block to be cooled (S150).

Moreover, fins can be disposed on the first casing and/or the second casing in order to divide the channel space into a plurality of flow channels.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A water block, comprising:
a first casing having a solder reserve area formed on an outer edge thereof;
a solder paste coated on the solder reserve area; and
a second casing jointed with the first casing via the solder past to form a channel space;
wherein the solder reserve area is a gap formed at a joint between the first casing and the second casing.

2. The water block as claimed in claim 1, wherein the solder past is composed of tin solder and flux, and the flux occupies about 5˜15% of the content of the tin solder.

3. The water block as claimed in claim 1, wherein the solder paste has a soldering temperature of between 200˜400° C.

4. The water block as claimed in claim 1, wherein the first casing has a plurality of fins.

5. The water block as claimed in claim 4, wherein the fins divide the channel space into a plurality of flow channels.

6. The water block as claimed in claim 1, wherein the second casing has a plurality of fins.

7. The water block as claimed in claim 6, wherein the fins divide the channel space into a plurality of flow channels.

8. The water block as claimed in claim 1, wherein the solder reserve area is formed inside the joint between the first casing and the second casing.

9. The water block as claimed in claim 1, wherein the solder reserve area is formed outside the joint between the first casing and the second casing.

10. The water block as claimed in claim 1, wherein the solder reserve area is formed inside and outside the joint between the first casing and the second casing.

11. A water block, comprising:
a first casing having a solder reserve area formed on an outer edge thereof;
a third casing having a solder reserve area formed on an outer edge thereof;
a solder paste coated on the two solder reserve areas; and
a second casing jointed with the first casing and the third casing via the solder past to form a channel space;
wherein the two solder reserve areas are two gaps respectively formed at two joints between the first casing and the second casing and between third casing and the second casing.

12. The water block as claimed in claim 11, wherein the solder past is composed of tin solder and flux, and the flux occupies about 5˜15% of the content of the tin solder.

13. The water block as claimed in claim 11, wherein the solder paste has a soldering temperature of between 200˜400° C.

14. The water block as claimed in claim 11, wherein the first casing has a plurality of fins.

15. The water block as claimed in claim 14, wherein the fins divide the channel space into a plurality of flow channels.

16. The water block as claimed in claim 11, wherein the second casing has a plurality of fins.

17. The water block as claimed in claim 16, wherein the fins divide the channel space into a plurality of flow channels.

18. The water block as claimed in claim 11, wherein the two solder reserve areas are respectively formed inside the two joints between the first casing and the second casing and between third casing and the second casing.

19. The water block as claimed in claim 11, wherein the two solder reserve areas are respectively formed outside the two joints between the first casing and the second casing and between the third casing and the second casing.

20. The water block as claimed in claim 1, wherein the two solder reserve areas are respectively formed inside and outside the two joints between the first casing and the second casing and between the third casing and the second casing.

21. A method of manufacturing a water block, comprising:
providing a first casing that has a solder reserve area formed on an outer edge thereof;
coating a solder paste on the solder reserve area, wherein the solder past is composed of tin solder and flux, and the flux occupies about 5˜15% of the content of the tin solder;
jointing a second casing with the first casing via the solder past to form a channel space; and
separating the flux from the tin solder and removing bubbles of the tin solder from the solder reserve area at a soldering temperature of between 200˜400° C.

22. The water block as claimed in claim 21, wherein the solder reserve area is a gap formed at a joint between the first casing and the second casing.

23. The water block as claimed in claim 21, wherein the first casing has a plurality of fins.

24. The water block as claimed in claim 23, wherein the fins divide the channel space into a plurality of flow channels.

25. The water block as claimed in claim 21, wherein the second casing has a plurality of fins.

26. The water block as claimed in claim 25, wherein the fins divide the channel space into a plurality of flow channels.

27. The water block as claimed in claim 21, wherein the solder reserve area is formed inside the joint between the first casing and the second casing.

28. The water block as claimed in claim 21, wherein the solder reserve area is formed outside the joint between the first casing and the second casing.

29. The water block as claimed in claim 21, wherein the solder reserve area is formed inside and outside the joint between the first casing and the second casing.
